(19) United States
(12) Patent Application Publication
(10) Pub. No.: US 2005/0204877 A1
(43) Pub. Date: Sep. 22, 2005

(54) TALKING SCREWDRIVER

(76) Inventor: James A. Royko, Porter, IN (US)

Correspondence Address: HARTMAN & HARTMAN, P.C., 552 EAST 700 NORTH, VALPARAISO, IN, 46383, US

(21) Appl. No.: 10/906,990

(22) Filed: Mar. 15, 2005

Related U.S. Application Data
(60) Provisional application No. 60/521,236, filed on Mar. 17, 2004.

(51) Int. Cl. B25B 23/14

(52) U.S. Cl. 81/479

(57) ABSTRACT

A screwdriver that produces an audible sound, such as a verbal message, when used, and to a method of using a screwdriver. The screwdriver comprises a handle, a shaft extending from the handle, a memory storage device within the handle and storing a message, and components for delivering and broadcasting the message from the memory storage device when the shaft is subjected to a torsional force during use of the screwdriver that exceeds a predetermined torsional. The method entails using a screwdriver so as to subject the shaft thereof to a torsional force and, in response to the torsional force exceeding a predetermined torsional force, delivering and broadcasting a message stored on a memory storage device within the handle of the screwdriver.

### CROSS REFERENCE TO RELATED APPLICATIONS

This application claims the benefit of U.S. Provisional Application No. 60/521,236, filed Mar. 17, 2004.

### BACKGROUND OF THE INVENTION

The present invention generally relates to tools, and more particularly to tools that produce an audible sound during use.

Various hand-operated devices are known that produce an audible sound when used. For example, U.S. Pat. No. 3,664,186 to Kraus, U.S. Pat. No. 4,535,659 to Yang, and U.S. Publication No. 2002/0178876 to Wang et al. disclose hand tools (wrenches) that produce an audible signal when a certain torque level is reached during use. In addition, U.S. Pat. No. 6,536,306 to Harris and European Patent EP000279194 to Oelkers disclose tools (bottle openers) that can play a message when used.

### BRIEF SUMMARY OF THE INVENTION

The present invention provides a screwdriver that produces an audible sound, and particularly a verbal message, when used, and to a method of using such a screwdriver.

The screwdriver comprises a handle, a shaft extending from the handle and terminating in means for engaging a screw head, a memory storage device within the handle and which stores a message, and means for delivering and broadcasting the message from the memory storage device when the shaft is subjected to a torsional force that exceeds a predetermined torsional force.

The method comprises using a screwdriver so as to subject the shaft thereof to a torsional force and, in response to the torsional force exceeding a predetermined torsional force, delivering and broadcasting a message stored on a memory storage device within the handle of the screwdriver.

In view of the above, it can be seen that the invention provides a screwdriver suitable for use in the same manner as a conventional screwdriver, but with the capability of producing an audible sound for purposes of entertainment, safety, etc.

Other objects and advantages of this invention will be better appreciated from the following detailed description.

### BRIEF DESCRIPTION OF THE DRAWINGS

FIG. 1 schematically represents a screwdriver in accordance with the present invention, with the handle of the screwdriver shown in cross-section to reveal internal components within the handle.

### DETAILED DESCRIPTION OF THE INVENTION

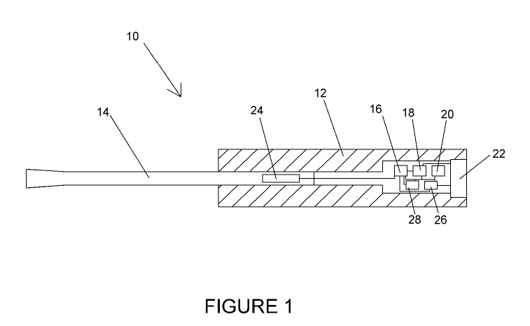

FIG. 1 schematically represents a screwdriver 10 conventionally equipped with a handle 12 and shaft 14 that terminates in a blade for engaging a slotted screw head, though it is foreseeable that the blade could be adapted to engage a Philips screw or other type of fastener head. The handle 12 is represented as containing a memory storage device 16, amplifier 18, power source (e.g., battery) 20, and speaker 22. The memory storage device 16 may be a read-only memory (ROM) device adapted to store permanent messages. Alternatively, the device 16 can be a memory device that permits the recording of messages by the user of the screwdriver 10. One such device is an EEPROM (electrically erasable programmable read-only memory) device. Other suitable devices known now or discovered in the future are also within the scope of this invention. For the purpose of recording messages, the handle 12 is depicted as also containing an audio recording unit 26 that uses the speaker 22 as a microphone to deliver messages for storing on the memory storage device 16.

The shaft 14 of the screwdriver 10 is equipped with a sensing device 24, such as a switch, strain gauge, or other suitable device capable of sensing torsional strain of the shaft 14, movement or shear forces between the shaft 14 and the handle 12, etc., so that the message stored in the memory storage device 16 is played only when the screwdriver 10 is used such that the shaft 14 is subjected to a torsional load that exceeds some predetermined torsional load. For example, the message could be played only when the torsional load is sufficient to close a switch between the shaft and the handle, or the torsional load induces strain in the shaft or handle that exceeds a certain strain threshold, evidencing that the user is applying considerable effort to tighten or loosen a screw.

Any number of messages can be stored on the memory storage device 16, and can be in the form of any audible noise including words, such as swearing for entertainment purposes, etc. Which message is broadcast and the volume at which it is broadcast can be regulated with a controller 28 on the basis of, for example, the torsional load on the shaft 14.

While the invention has been described in terms of a specific embodiment, it is apparent that other forms could be adopted by one skilled in the art. For example, the physical configuration of the screwdriver 10 and the choice and arrangement of internal components could differ from that shown. Accordingly, it should be understood that the invention is not limited to any specific embodiment. It should also be understood that the phraseology and terminology employed above are for the purpose of disclosing the embodiment, and do not necessarily serve as limitations to the scope of the invention. Therefore, the scope of the invention is to be limited only by the following claims.

1. A screwdriver comprising:
a handle;
a shaft extending from the handle and terminating in means for engaging a screw head;
a memory storage device within the handle and storing a message; and
means for delivering and broadcasting the message from the memory storage device when the shaft is subjected to a torsional force during use of the screwdriver that exceeds a predetermined torsional force.

2. The screwdriver according to claim 1, wherein the memory storage device is configured as read only memory and the message is one of a plurality of stored permanent messages in the memory storage device.

3. The screwdriver according to claim 1, wherein the memory storage device is configured as read and write memory, the message is recorded by a user of the screwdriver, and the screwdriver further comprises means for recording the message.

4. The screwdriver according to claim 1, wherein the delivering and broadcasting means comprises a switch physically interconnected with the shaft to cause the message to be delivered and broadcast when the shaft is subject to the predetermined torsional load.

5. The screwdriver according to claim 1, wherein the delivering and broadcasting means comprises a strain gauge physically interconnected with the shaft to cause the message to be delivered and broadcast when the shaft is subject to the predetermined torsional load.

6. The screwdriver according to claim 1, further comprising means for selecting the message from a plurality of messages stored on the memory storage device based on the extent to which the torsional force exceeds the predetermined torsional force.

7. A method of using a screwdriver having a handle and a shaft extending from the handle and terminating in means for engaging a screw head, the method comprising the steps of:
using the screwdriver so as to subject the shaft to a torsional force; and
in response to the torsional force exceeding a predetermined torsional force, delivering and broadcasting a message stored on a memory storage device within the handle.

8. The method according to claim 7, wherein the memory storage device is configured as read only memory and the message is one of a plurality of stored permanent messages that were permanently stored in the memory storage device.

9. The method according to claim 7, wherein the memory storage device is configured as read and write memory, the method further comprising the step of a user of the screwdriver recording the message using means within the handle for recording the message.

10. The method according to claim 7, wherein the message is delivered and broadcast as a result of a switch being operated when the shaft is subjected to the predetermined torsional load.

11. The method according to claim 7, wherein the message is delivered and broadcast as a result of a strain gauge being operated when the shaft is subjected to the predetermined torsional load.

12. The method according to claim 7, further comprising selecting the message from a plurality of messages stored on the memory storage device based on the extent to which the torsional force exceeds the predetermined torsional force.
